(19) United States
(12) Patent Application Publication
(10) Pub. No.: US 2021/0007366 A1
(43) Pub. Date: Jan. 14, 2021

(54) IN-LINE NITROGEN PROTEIN CHILLING APPARATUS FOR A VACUUM SEPARATOR

(71) Applicant: Messer Industries USA, Inc., Bridgewater, NJ (US)

(72) Inventors: John C. Hamilton, Edmond, OK (US); Robert Skobel, Rockwall, TX (US)

(73) Assignee: Messer Industries USA, Inc., Bridgewater, NJ (US)

(21) Appl. No.: 16/922,297

(22) Filed: Jul. 7, 2020

Related U.S. Application Data
(60) Provisional application No. 62/871,359, filed on Jul. 8, 2019.

(51) Int. Cl. A23B 4/09; A23B 4/30; A23B 4/06

(52) U.S. Cl. CPC A23B 4/09; A23V 2002/00; A23B 4/066; A23B 4/30

(57) ABSTRACT

An apparatus for chilling protein products consists of a container including a processing chamber therein for receiving protein products in the processing chamber; and a processing atmosphere in the processing chamber, the processing atmosphere including a transport vacuum and a chilling substance for application to the protein products. A method for chilling protein products is also provided which consists of receiving protein products in a processing chamber of a container; and providing a vacuum and a chilling substance to the processing chamber for providing a processing atmosphere to chill the protein products therein.

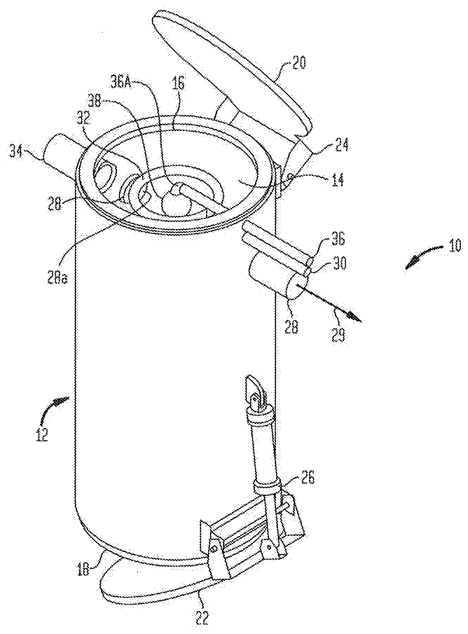

### BACKGROUND OF THE INVENTION

The present embodiments relate to rapidly chilling individual protein parts, such as for example chicken wings, chicken breasts and chicken tenders, with a cryogen substance while the parts are being transported through a processing plant for distribution into commerce.

It is standard and common practice to transport chicken parts to various physical locations throughout a first processing poultry manufacturing facility, for example. Each of the protein food parts requires heat removal at the various collection points. Current methods of temperature control and heat removal during this stage of processing require additional time to provide a homogenous product equilibration among the protein parts.

The two primary and traditional methods for removing heat also unfortunately incur additional costs for the heat transfer process and adversely impact the quality of the product. For example, water ice is an effective source for heat removal, but yields additional non-revenue weight (the actual ice) to the product for and during shipping of the product. CO₂ snow or ice, referred to in the industry as “dry-ice”, can also be an effective medium for heat removal, but will add variability in temperature control based upon mechanical handling and distribution relative to the exposed surface area of the product, such as chicken parts.

### SUMMARY

There is therefore provided herein an in-line vacuum chilling transportation apparatus embodiment for protein products, such as for example protein food products.

Another embodiment of the present apparatus calls for same to be retrofitted to an existing processing line or to be part of a new processing line being constructed at a food processing plant.

Still another embodiment of the apparatus includes at least one sensor, a cryogen injector and a controller in communication with the at least one sensor, the cryogen injector and possibly other components of the system for efficient chilling during vacuum transport of the protein parts for processing.

More particularly, there is provided herein an apparatus embodiment for chilling protein products, comprising a container including a processing chamber therein for receiving protein products in the processing chamber; and a processing atmosphere in the processing chamber, the processing atmosphere including a transport vacuum and a chilling substance for application to the protein products.

Another embodiment of the apparatus includes a clean-in-place (CIP) device disposed at the processing chamber for delivering to the processing chamber a substance selected from the group consisting of a cleaning solution, a rinsing solution, hot water, potable water, a disinfectant, and combinations thereof.

Another embodiment of the apparatus calls for the CIP device to be for example a spray ball, at least one or a plurality of spray nozzles, etc.

Another embodiment of the apparatus includes an exhaust in fluid communication with the processing chamber and through which vapor from the chilling substance may be removed from the processing chamber.

Another embodiment of the apparatus includes a delivery device for the chilling substance, the delivery device disposed at the processing chamber above the protein products in the processing chamber.

Another embodiment of the apparatus calls for the delivery device for the chilling substance to be selected from the group consisting of a spray ring, at least one nozzle, and a manifold.

Another embodiment of the apparatus includes the chilling substance comprising liquid nitrogen (LIN).

Another embodiment of the apparatus includes the container being a device selected from the group consisting of a vacuum separator, a cyclone, a separation vessel, and a dump tank.

A method embodiment for chilling protein products is also provided herein, the method embodiment comprising receiving protein products in a processing chamber of a container; and providing a vacuum and a chilling substance to the processing chamber for providing a processing atmosphere to chill the protein products therein.

Another embodiment of the method includes providing the vacuum and the chilling substance simultaneously.

Another embodiment of the method includes venting vapor from the processing chamber.

Another embodiment of the method includes at least one of rinsing, cleaning and disinfecting the processing chamber without the protein products therein.

Another embodiment of the method includes the chilling substance being liquid nitrogen (LIN).

### BRIEF DESCRIPTION OF THE DRAWINGS

For a more complete understanding of the present invention, reference may be had to the following description of exemplary embodiments considered in connection with the accompanying drawing FIGURES(S), of which:

The FIGURE shows a side perspective view of an embodiment of an in-line nitrogen protein chilling apparatus for a vacuum separator.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

Referring to the FIGURE, there is shown an in-line nitrogen protein chilling apparatus 10 for a vacuum separator of the present embodiments. The apparatus 10 includes a vessel 12 or container which is constructed of, for example, stainless steel suitable for food product processing. The vessel 12 may be insulated with any of the known materials used for same in the food processing industry. The vessel 12 may be a cyclone, separation vessel, vacuum separator or a dump tank.

The vessel 12 has a plurality of pipelines or conduits in communication with an interior 14 of the vessel. The vessel also includes an open upper end 16 and an opposed open lower end 18. A movable top hatch 20 or door provides access to and can seal or close off the upper end 16, while a movable bottom hatch 22 or door provides access to and can seal or close off the lower end 18. The top and bottom hatches 20,22 may also be insulated, and operable with known opening and closing mechanisms 24,26, respectively. The top and bottom hatches 20,22 are constructed and arranged to be in registration with a respective one of the openings 16,18 to form an air-tight seal at the openings to provide and maintain a vacuum at the interior when the hatches 20,22 are closed against the openings.

A pipeline 28 or pipe has an internal passage or conduit under the effect of a vacuum for a purpose to be described below. The pipe 28 may be for example from two inches to eight inches (2″-8″) in diameter to accommodate the different sized protein products that will be transported through the pipe to the vessel 12 under the effect of the vacuum. The protein parts can be for example chicken and/or other poultry parts. The pipe 28 can be constructed from food grade stainless steel, and includes a proximate end 28a connected to the vessel 12 and in communication with the interior 14 for delivering the protein parts to the interior for chilling, and a distal end (not shown) connected to and in communication with a remote pump source providing the vacuum. As shown in the FIGURE, the vessel 12 of the apparatus 10 is interposed in-line with respect to the pipeline 28. This is necessary for the vacuum to draw the protein products from a remote location (not shown) through the pipe 28 out of the proximate end 28a and into the interior 14 of the vessel 12 for chilling. The vacuum and movement of the protein parts through the pipe 28 is in the direction of the arrow 29.

A pipeline 30 or pipe has an internal passage or conduit, and a proximate end connected to and in communication with the interior 14 of the vessel 12, while a distal end (not shown) of the pipeline is in fluid communication with a remote source (not shown) of liquid nitrogen (LIN). The pipeline 30 delivers the LIN to the vessel 12. The proximate end of the pipeline 30 may extend into the interior 14 and terminate in an injection device 32, such as for example an injection ring, at least one nozzle, and/or a manifold at the interior for introduction of the LIN to the interior and to contact the protein products deposited therein from the pipe 28. The injection ring 32 is positioned at an upper region of the interior 14 above where the pipe 28 proximate end 28a introduces the protein products into the interior for chilling, so that the products do not contact or foul the operation of the injection ring, and receive the benefit of heat transfer from the LIN.

The LIN introduced into the interior 14 of the vessel 12 contacts the protein food products in the vessel to chill same, resulting in the LIN flashing almost instantaneously to nitrogen vapor. This cryogen vapor is removed from the interior 14 through the pipe 28 in the direction of the arrow 29 and, if the volume of vapor is such that further venting is needed, an exhaust pipeline 34 or pipe is in communication with the interior to vent the vapor to the atmosphere external to the vessel 12. The exhaust pipeline 34 is in communication with an upper region of the interior 14 to remove as much of the vapor as possible from the interior. The cryogenic vapor may also be removed from the interior 14 by being pulled through the pipe 28 with the vacuum being drawn through same and be exhausted through the vacuum pump (not shown) to the atmosphere external to the vessel 12.

A pipeline 36 or pipe has a proximate end 36a in communication with the interior 14 of the vessel 12, while a distal end (not shown) of the pipeline is in fluid communication with a remote source of a clean-in-place (CIP) solution and/or substance, i.e. cleaning, rinsing and/or disinfecting solution, collectively “cleaning solution” (not shown). The proximate end 36a of the pipeline 24 may be provided with a CIP device 38 such as for example a spray ball and/or at least one nozzle (not shown) to provide the cleaning solution to the interior 14 of the vessel 12.

The open lower end 18 provides an exit or outlet which is accessed by the bottom hatch 22 from which the chilled products can be removed from the vessel interior 14 and directed to a further processing step which may include any one of further processing, storage, packaging, transport, or a combination for example. The movable hatches 20,22 are each constructed and arranged to be in registration with the corresponding open end 16,18 of the vessel 12, such that when the respective hatch is closed it will form a seal at the open ends 16,18 to permit the vacuum to be drawn to and at the interior 14, whereby the protein products are drawn into the vessel 12 for chilling.

Valves (not shown) may be used to control the flow or lack thereof of the vacuum, the LIN and the CIP cleaning solution. The valves may be constructed from food grade stainless steel components or from other materials conducive to food processing.

In operation, the protein parts are vacuum transported from a remote location to the interior 14 of the vessel 12, where the vessel is in chilling mode with the products therein if there is a demand for chilling of the products in the vessel as signaled by sensors (not shown) and provided that all other conditions are met (e.g., the exhaust 34 is on and open, and that other conditions are met based upon an engineering audit of the apparatus). The protein products are removed from the interior 14 through the open lower end 18 after the products have been chilled sufficiently by the LIN introduced from the injection device 32. The chilling operation can be timed, but may also be controlled by different variables present in the apparatus 10 such as for example: weight of the protein products, temperature of the protein products, temperature of the interior 14 of the vessel 12, production rates needed for the apparatus 10 and/or the products, or a combination of one or more of these variables.

The present embodiments also provide an optimal uniform and final temperature of the protein parts, elimination of manual labor during the transport and the chilling or freezing process, and minimizes cleaning and related processing costs.

The present apparatus 10 and related method embodiments provide for efficient, cost-effective temperature control and process for heat removal or heat transfer for protein food products being transported through a processing plant prior to a final point of collection of the products. A chicken part, for example, is encompassed (shrouded) in a cryogen (gas/vapor) such as for example nitrogen (N₂) during its vacuum transport through the processing plant to rapidly remove heat from the part so that same is at a desired temperature upon reaching the next or final stage of processing or collection.

It will be understood that the embodiments described herein are merely exemplary, and that a person skilled in the art may make variations and modifications without departing from the spirit and scope of the invention. All such variations and modifications are intended to be included within the scope of the invention as provided in the appended claims. It should be understood that the embodiments described above are not only in the alternative, but can be combined.

What is claimed is:

1. An apparatus for chilling protein products, comprising:
a container including a processing chamber therein for receiving protein products in the processing chamber; and a processing atmosphere in the processing chamber, the processing atmosphere including a transport vacuum and a chilling substance for application to the protein products.

2. The apparatus of claim 1, further comprising a clean-in-place device disposed at the processing chamber for delivering to the processing chamber a substance selected from the group consisting of a cleaning solution, a rinsing solution, hot water, potable water, a disinfectant, and combinations thereof.

3. The apparatus of claim 1, further comprising an exhaust in fluid communication with the processing chamber and through which vapor from the chilling substance may be removed from the processing chamber.

4. The apparatus of claim 1, further comprising a delivery device for the chilling substance, the delivery device disposed at the processing chamber above the protein products in the processing chamber.

5. The apparatus of claim 4, wherein the delivery device for the chilling substance is selected from the group consisting of a spray ring, at least one nozzle, and a manifold.

6. The apparatus of claim 1, wherein the chilling substance comprises liquid nitrogen (LIN).

7. The apparatus of claim 1, wherein the container is a device selected from the group consisting of a vacuum separator, a cyclone, a separation vessel, and a dump tank.

8. A method for chilling protein products, comprising:
receiving protein products in a processing chamber of a container; and providing a vacuum and a chilling substance to the processing chamber for providing a processing atmosphere to chill the protein products therein.

9. The method of claim 8, wherein the providing the vacuum and the chilling substance occurs simultaneously.

10. The method of claim 8, further comprising venting vapor from the chilling substance from the processing chamber.

11. The method of claim 8, further comprising at least one of rinsing, cleaning, and disinfecting the processing chamber without the protein products therein.

12. The method of claim 8, wherein the chilling substance comprises liquid nitrogen (LIN).

13. The method of claim 8, further comprising shrouding the protein products in vapor from the chilling substance; and transporting the shrouded protein products with the vacuum to a remote location.
